(19) United States
(12) Patent Application Publication
(10) Pub. No.: US 2006/0174123 A1
(43) Pub. Date: Aug. 3, 2006

(54) System and method for detecting, analyzing and controlling hidden data embedded in computer files

(76) Inventors: Ronald D. Hackett, Fayetteville, TN (US); Edward Troy, Huntsville, AL (US); John D. Nord, Toney, AL (US); David Casey Johnson, Madison, AL (US)

Correspondence Address: W. EDWARD RAMAGE, COMMERCE CENTER SUITE 1000, 211 COMMERCE ST, NASHVILLE, TN, 37201, US

(21) Appl. No.: 11/146,720

(22) Filed: Jun. 7, 2005

Related U.S. Application Data
(60) Provisional application No. 60/647,890, filed on Jan. 28, 2005.

(51) Int. Cl. H04L 9/00

(52) U.S. Cl. 713/175

(57) ABSTRACT

A system and method for detecting, analyzing, and controlling the content of computer files and information in a variety of formats, including embedded information. The system examines one or more computer files in their entirely, including any embedded files, objects, or data, looks of confidential or secret information according to an established security search protocol, which may vary from user to user. Objects in a computer file are identified and decomposed into component objects. This process can be repeated until a user-specified depth of decomposition is achieved, or until the component objects can no longer be decomposed. The component objects are then analyzed for specific content, which is displayed for review by the user. The user can then make decisions regarding removal or modification of that content before sending the file on for further processing or delivery to a recipient. A certificate file linked to the computer file documents the results of the analysis and any deletions or modifications, and can be stored in a central database. Files also may be given a risk score based on the occurrence of certain objects, data, or keywords in a file, based on type and location.

This application claims priority in whole or in part to U.S. Provisional Application No. 60/647,890, filed Jan. 28, 2005, by Ronald Hackett, Edward Russell Troy, John Nord, and David Casey Johnson, and is entitled to the filing date thereof for priority. The specification and materials of U.S. Provisional Application No. 60/647,890 are incorporated herein by reference.

### TECHNICAL FIELD

The invention relates generally to computer software. More specifically, the invention relates to a system and method for detecting, analyzing and controlling hidden data and computer files that are embedded in a master computer file. Computer files containing user data are also called electronic documents.

### BACKGROUND OF THE INVENTION

As compatible computer software packages become more and more widely used and accepted, it is not uncommon to encounter documents that have content that comes from a “cut and paste” procedure. Such documents are typically produced by taking content from one application, such as a spread sheet or word processor application, and using portions of that content in a document in a compatible but separate application. These amalgamations of information into single, monolithic files are commonly referred to as “desktop publishing.” Software applications and application suites, such as Microsoft Office®, are integrated on such a level that data may be seamlessly integrated to produce a professional-looking document by a relatively inexperienced user. Specifically, Microsoft's Object Linking and Embedding (OLE) standard is used to integrate various software packages. The introduction of collaboration tools, like those found in the most recent editions of Microsoft Office®, have further enhanced desktop publishing's capabilities.

However, documents created by desktop publishing applications may contain sensitive, privileged or national security (classified) information that is not detected by or known to the author or a reviewer of the material. Some of this data is in the form of “embedded” objects or files. Embedded objects may be a particular problem with documents that contain information related to national security. For example, the users of a classified network security system typically are required to submit their traffic to a security review before it passes to its intended destination. In such security systems, documents must be subject to human review before they can be transferred by a user in a classified network to a destination with a lower or no security classification. Current procedures typically require a user who is knowledgeable about the subject matter contained in the electronic document to conduct a 100% reliable human review of the electronic document to ensure that sensitive material is not sent out from the network. This means that the user is supposed to review all (i.e., 100%) of the data that is contained in the electronic document. While the requirement to conduct this review is well documented in federal government regulations, the tools and procedures to conduct this review are poorly developed or non-existent.

As the need to share information increases, the demands placed on security personnel increase dramatically with the network traffic flow. However, security personnel may not have the time, knowledge or capability to review documents for embedded information. A reviewer may use keyword or “dirty word” scanners to search outgoing documents for sensitive words. However, these scanners may not be adequate to search the entire contents of a document, and may miss embedded data. The scanners also typically assume that all the information in a document is stored in a known format. Many applications use data formats that are unknown to the keyword scanner. Adobe's portable document format (PDF) is a good example of a data format that cannot be interpreted using a keyword scanner. Commercial search engines, such as Google, convert PDF documents into Hypertext Markup Language (HTML) documents for scanning and indexing. Also, file compression is becoming a more common technique that is used to increase data transfer rates, but portions of a compressed document may be unreadable to a keyword scanner. As a result, classified or confidential information may be unintentionally and unwittingly disclosed.

Accordingly, what is needed is an efficient, comprehensive system and method for detecting, analyzing, and controlling the content of computer files of all formats, including embedded computer files.

### SUMMARY OF INVENTION

The present invention is directed to a system and method for detecting, analyzing, and controlling the content of computer files and information in a variety of formats, including embedded information. The term “embedded” is used to describe data, files, objects, or other digitally stored information that is not readily detectable by a user or security reviewer. The user may not be able to detect embedded information either by visual inspection or by use of document searching devices such as keyword scanners. Examples of sources of embedded information include embedded files or objects, meta-data, file fragmentation, and highly formatted information or data.

In one exemplary embodiment, a user desiring to transfer an electronic document across a security boundary to reach a customer or other recipient reviews that document with an “Electronic Document Processor” (EDP). The EDP examines the electronic document in its entirety, including any embedded files, objects, or data, and looks for confidential or secret information according to an established security search protocol. The search protocol may vary from system to system, or user to user.

A significant part of the analysis is conducted by a “Document Detection Engine” (DDE), which is a component of the EDP. The analysis process involves identifying the types of objects in the file or document, and then breaking down those objects into various components, which are subsequently identified as well. The component objects are then analyzed and examined for specific content, which is reported to the user. The user determines whether certain objects and concomitant information should be modified or deleted. The modified objects are then reassembled into a “clean” version of the file or document, which can then be transferred to a recipient, or be subjected to further layers of security review. A certificate documenting the analysis and modifications is created or modified at critical steps in the process, and is stored in a database.

The DDE verifies and analyzes any certificate attached to the document, then proceeds to analyze the file or document. In one exemplary embodiment, the DDE identifies the objects in the document, and decomposes those objects into their component parts. This process repeats and continues until all elemental objects (objections that cannot be further divided into meaningful objects) are recovered. The elemental objects are then examined and analyzed. Confidential and secret information is identified and displayed for review by the user, who then makes decisions regarding whether the information in question should be removed, modified, or kept. If no further review is called for as part of the security procedure, a modified document can then be sent to the recipient.

In another exemplary embodiment, the EDP creates a “certificate” that documents the results of the analysis and review. The certificate may be attached to the document. The certificate may annotate any discrepancies within the document, and generate a unique signature to ensure that no unauthorized changes to the document are made. When the reviewing process is complete, the certificate is detached from the modified document and sent to a database for storage.

In yet another embodiment, the EDP allows for review of a document by multiple reviewers, as may be required by some security procedures. This may be a second knowledgeable user or person, or an office manager or administrator, or security personnel. The certificate remains attached to the document as it proceeds through these multiple reviews and is updated to document the results of each review. Each subsequent reviewer can examine the results of prior analyses and reviews.

In another exemplary embodiment, electronic documents may be scored or ranked based on a variety of factors, such as, but not limited to, the presence of certain keywords or object types, the number and location of certain keywords or objects, and the type of file or objects. The scoring algorithm accounts for the variable risks associated with different objects and data within the electronic document by assigning weights thereto, and then summing the weighted occurrences of all objects.

In another exemplary embodiment, the EDP comprises a graphical user interface that facilitates use of the EDP and its components. The graphical user interface can encompass standard well-known interfaces such as Microsoft's File Explorer®. The information may be displayed in a hierarchical fashion to provide the user ready access to 100% of the data contained in an electronic document.

Other aspects and advantages of various embodiments of the invention will be apparent to those skilled in the art from the following description wherein there is shown and described exemplary embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### BRIEF DESCRIPTION OF THE DRAWINGS

It should be noted that identical features in different drawings are shown with the same reference numeral.

FIG. 1 shows a diagram of a prior art network security system.

FIG. 2a shows an example of a presentation graph containing classified information.

FIG. 2b shows an example of a cropped view of the presentation graph shown in FIG. 2a.

FIG. 3 shows an example of embedded data files.

FIG. 4 shows an example of embedded meta data.

FIG. 5 shows a diagram of a de-fragmenting operation.

FIG. 6 shows a diagram of a system and method for detecting and analyzing embedded computer files in accordance with one embodiment of the present invention.

FIG. 7 shows a diagram of a document detection engine (DDE) protocol in accordance with one embodiment of the present invention.

FIG. 8 shows several screenshots of the DDE GUI interface.

FIG. 9 shows a screenshot of the DDE identifying keywords in a text box.

FIG. 10 shows two examples of classification tagged image files.

FIG. 11 shows screenshots of a document transfer confirmation and associated email dialog boxes.

FIG. 12 shows a screenshot of a classification dialog box.

FIG. 13 shows a screenshot of a batch load initialization dialog box.

### DESCRIPTION OF EXEMPLARY EMBODIMENTS

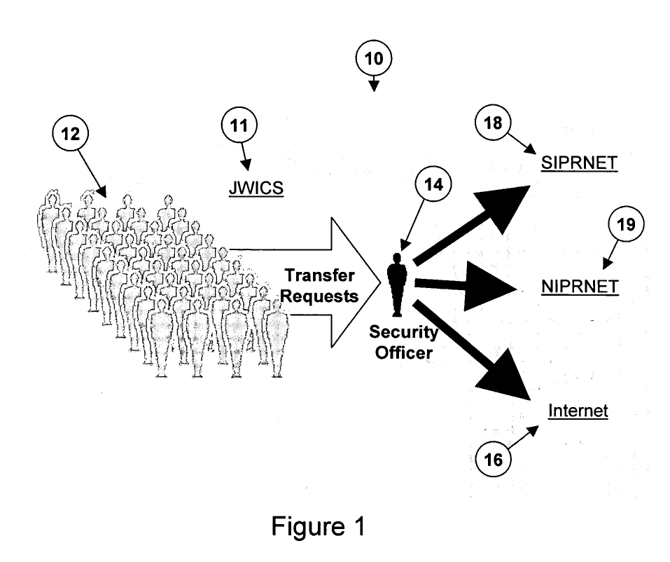

FIG. 1 shows a diagram of a prior art network security system 10. The users 12 of a classified network 11 must submit their traffic to a security review 14 before it passes to its intended destination. In this example, the destination may be the Internet 16 or the Secret Internet Protocol Router Network (SIPRNET) 18. SIPRNET is an isolated Internet-like network that the federal government uses for classified information. Some other isolated Internet-like networks used by the federal government are the Non-Secure Internet Protocol Router Network (NIPRNET) 19, which is used for unclassified but sensitive information, and the Joint Worldwide Intelligence Communications System (JWICS) 11, which is used for classified Intelligence information. In such security systems, documents must be subject to human review before they can be transferred by a user in a classified network to a destination with a lower or no security classification. Current procedures typically require a user who is knowledgeable about the subject matter contained in the electronic document to conduct a 100% reliable human review (i.e., the user is supposed to review 100% of the data contained in the document) of the electronic document to ensure that sensitive material is not sent out from the network. The prior-art tools and procedures to conduct this review are poorly developed or non-existent, particularly due to the presence of embedded objects and data in the electronic documents.

The term “embedded” is used to describe data, files, objects, or other digitally stored information that is not readily detectable by a user or security reviewer. The user may not be able to detect embedded information either by visual inspection or by use of document searching devices such as keyword scanners. Examples of sources of embedded information include embedded files or objects, meta-data, file fragmentation, and highly formatted information or data.

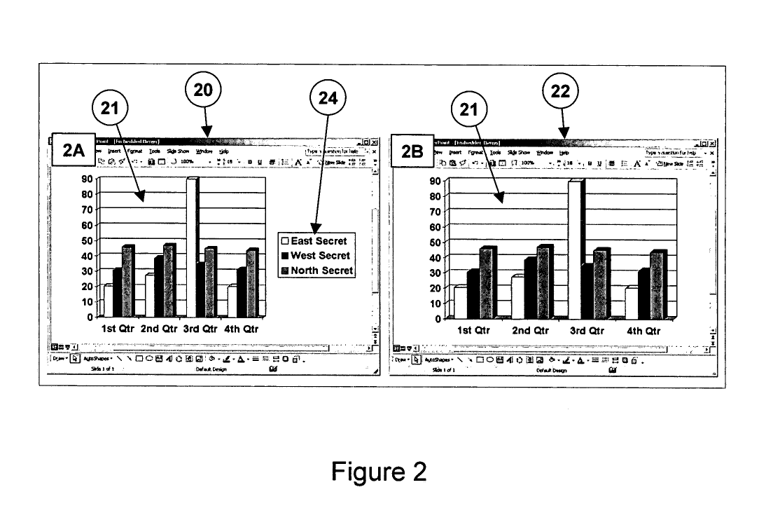

An example of how embedded data can be created is shown in FIGS. 2a and 2b, which shows a presentation slide of a graph that contains embedded classified information. FIG. 2a shows a screen shot 20 of the graph 21, which displays data from an embedded spreadsheet database. The graph contains a legend 24 that contains a keyword of “Secret” that indicates it is classified information. FIG. 2b shows a screen shot 22 of the same graph 21 with the legend “cropped” out for the slide. Such cropping is done with common application tools that are used to prepare slides. It is typically done due to space limitations or for aesthetic purposes. However, the information in the “cropped” legend has not been discarded from the file. Instead, the cropped information is still contained within the file even though it is not displayed on the slide. The classification label will not be detected by the human reviewer and it will not be picked up by a keyword scanner looking for the word “Secret” because this embedded object has been compressed. Even more problematic is the possibility that the embedded objects themselves may contain still other embedded objects. There is no theoretical limit to the number of embedded objects that may be nested in a single document.

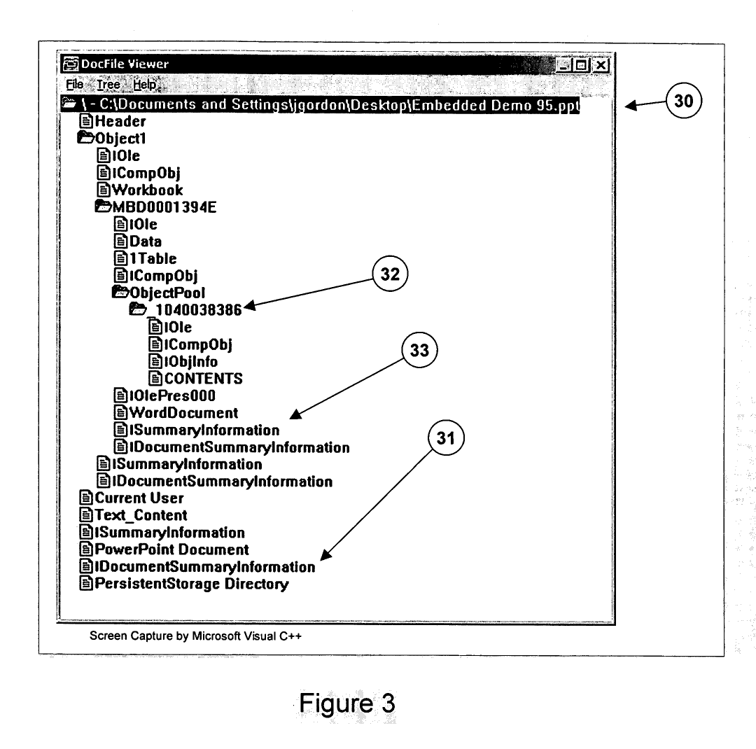

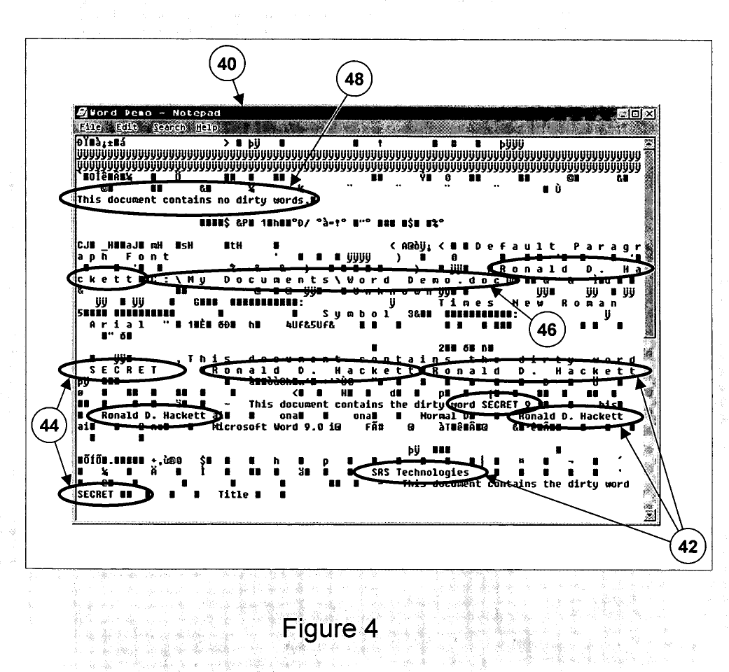

Another example of embedded information is meta-data, or administrative information about the file itself. An OLE file may contain a great deal of administrative information about itself that is hidden from a reviewer. Such meta-data information may include the following: a listing of the users who worked on the file; the author; the file name; the file location; the original, unsanitized text; and modifications and changes to the text over time. FIG. 3 shows an example of a data stream tree 30 listing embedded objects inside an OLE file, including summary information 31 about the document and an embedded OLE object 32 and its summary information 33. FIG. 4 shows an example of stored meta-data 40 for a simple document that currently contains the text of “This document contains no dirty words.” 48. The meta data includes the author and his company 42, the file location 46, and the unsanitized original text that the user tried to delete from the document (i.e., “This document contains the dirty word SECRET”) 44.

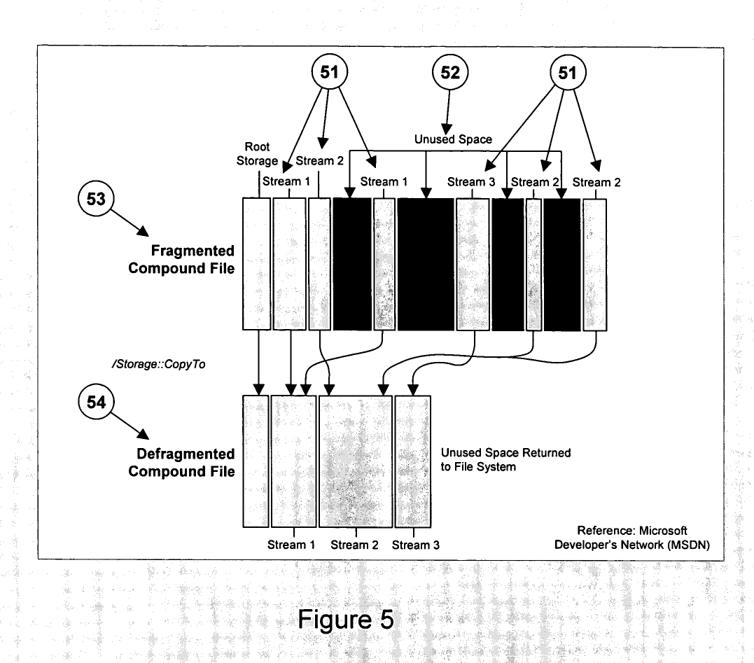

Another potential source of embedded data is file fragmentation. FIG. 5 shows a diagram of the defragmentation process for a typical file 50. OLE files have a complex, hierarchical structure that is the equivalent of a file system. Data in the file is typically broken up and stored in multiple data streams 51 at various locations inside the file 53. These locations are not necessarily contiguous as they are often surrounded by unused space 52 or space that is presently being used to store other data inside the file. As the file is retrieved, modified and re-saved, its fragmentation becomes even more pronounced. This is similar to the way files become fragmented on a storage media such as a hard disk drive or a floppy drive, but because this fragmentation occurs inside the file, disk defragmenting software (which takes fragmented files and relocates them to another location on the disk or drive in a contiguous order 54) will not defragment the data inside a computer file.

However, as data streams 51 of a file are moved to a new storage location within the file, the contents of the old storage location are not automatically erased. It is possible for this formerly used space to contain traces of original information that can be recovered. This same situation exists with data that have been “deleted” from the file. The deleted material is not automatically erased; instead, the application simply removes its internal information that points to where the data can be found. Consequently, the deleted information may possibly be recovered in whole or in part at a later time. Unlike fragments on the storage media, the “deleted” space inside a file is never overwritten with new data.

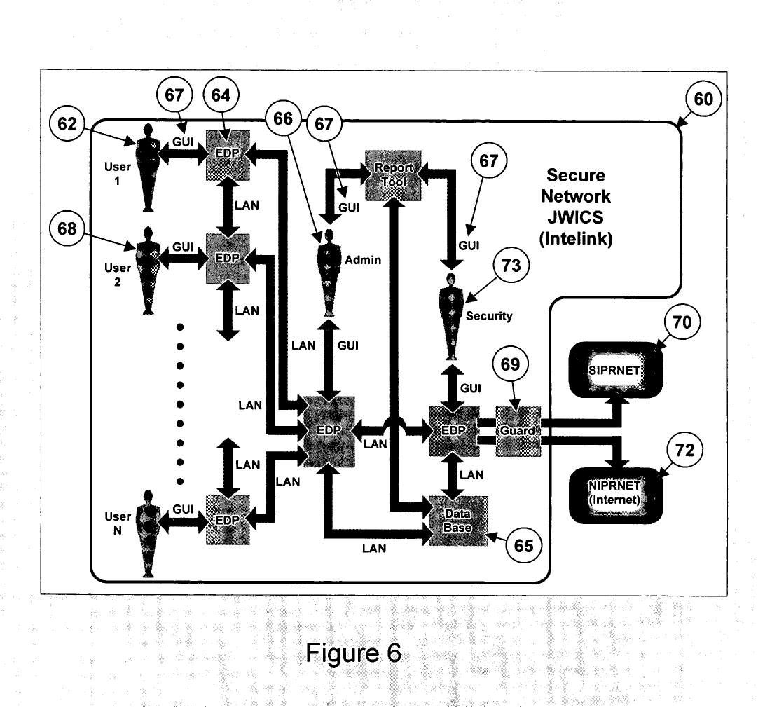

FIG. 6 shows a diagram of a system 60 for detecting and analyzing embedded computer files in accordance with one embodiment of the present invention. The system 60 includes at least one user 62 who has prepared an electronic document that must be transferred across the security boundary to reach the customer or other recipient 70, 72. The user uses a “Document Detection Engine” (DDE) 61, a significant component of an “Electronic Document Processor” (EDP), 64 to review that electronic document, which meets requirements for 100% reliable human review. The EDP may reside on the user's computer, on a central server, or some other component of a LAN on the “secure” side of the security boundary. The EDP examines the electronic document in its entirety, including any embedded files, objects or data, using the DDE and looking for confidential or secret information according to an established security search protocol. The search protocol may vary from system to system, or user to user.

At the end of the review, the EDP 64 creates a “certificate” that documents the review. The certificate may be attached to the document. The certificate may annotate any discrepancies within the document, and generates a unique signature to ensure that no unauthorized changes are made to the document once the review process begins. The reviewed electronic document and the certificate are then passed to the next level of review, such as an office manager or administrator 66. The transfer may be over a secure local area network. This level of review usually includes a review of the certificate and results of the EDP analysis.

Some security procedures may require a second knowledgeable user or person 68 to look over the material as part of the review process. This is commonly called the “Two Man Rule”. The present invention accounts for this requirement and allows for more than one reviewer. Each additional reviewer 68 uses the EDP 64 to process both the electronic document and its certificate. The EDP 64 provides the additional reviewers 68 with the annotations made during the earlier reviews. Each additional reviewer's 68 and office manager's or administrator's 66 information and recommendations are recorded in an updated document certificate.

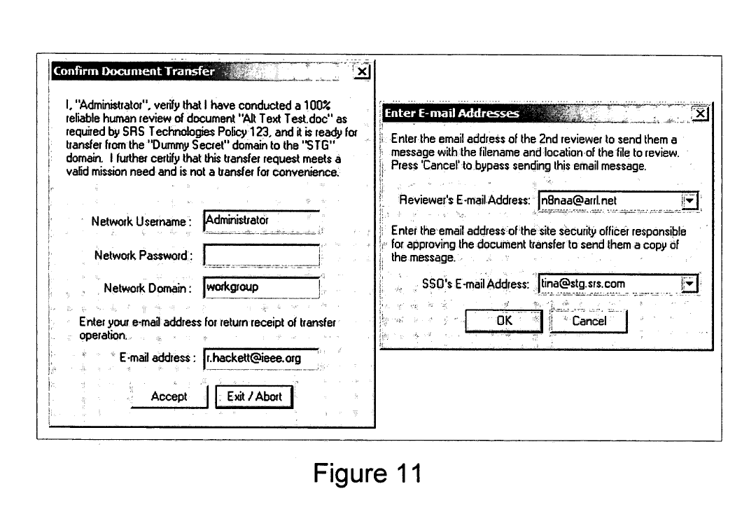

Because there is a risk with any data transfer across a security boundary, security procedures also may require confirmation that the information meets a valid customer need. This step typically requires approval by an administrative reviewer 66 or similar person for the electronic document transfer request. Theoretically, the administrative reviewer 66 should certify that the document meets a valid customer or other need. An example of such an authentication confirmation and related email dialog box is shown in FIG. 11. Through the EDP 64, the administrative reviewer 66 has full access to the document review and the certificate prior to approving the document for transfer. Once approved, the certificate is updated to show the approval, and a copy of the certificate is sent to a database to create an audit trail. The electronic document and certificate are then forwarded to the security reviewer or officer 73 who has the authority to approve the transfer of the electronic document across the security boundary 69 via the secure local area network.

Once received by the security reviewer 73, the document and its certificate are checked again by the EDP 64. If the review clears certain requirements, the document could be automatically transferred across the security boundary; however, the security protocol may require the security reviewer 73 to review any or all documents, or types of documents, prior to the transfer. For example, a user 62 may have allowed an embedded OLE object to remain in the document. There may be valid reasons for doing this, but this is an exception that the security reviewer 73 will probably want to review. The security reviewer 73 may also want to review random documents to check compliance with other security requirements. All transactions by the security reviewer 73 are recorded in the electronic document's certificate as well as the system database 65.

In an exemplary embodiment, the associated method for implementing this system comprises the following steps:

a. submitting the document or file to be transferred to the DDE;

b. analyzing the document or file with the DDE;

c. removing confidential or secret data from the document or file;

d. creating a certificate documenting the results of the DDE analysis and modification;

e. attaching the certificate to the modified document or file;

f. submitting the modified document/file and certificate to one or more subsequent reviewers for further review and analysis and possible modification;

g. scoring or ranking electronic documents based on their contents;

h. sorting the electronic documents into target domain specific locations or folders;

i. sending the certificate to a database; and

j. sending the modified document or file to a recipient.

Certificates may be used to provide a secure envelope for the document. Once a document has been submitted for transfer by a user, any changes to that document that occurs outside the DDE will invalidate the security review process. The certificate contains a record of all processing done on the file and a digital signature that is specific to that file. The signature is similar to a cyclical redundancy check (CRC). An alteration to the file outside the DDE would be detected and the transfer process would be terminated.

Scoring or ranking of documents is a method of determining the potential information security risk of an electronic document. In one exemplary embodiment, this is accomplished by examining the structure of the document and assigning risk factors based on the type and location of different data types and objects, including but not limited to keywords. The risk score may then be used to automate the processing of the electronic document, or a series of documents.

As an example, keywords of interest in a Microsoft Word® document can occur in many places throughout the electronic document. Keywords appearing in paragraphs, footnotes, and other normally visible areas of the document are more likely to have been seen by the reviewer, and thus constitute a lower risk than a keyword that occurs in a normally non-visible part of the document, such as in a comment or in Meta data. Similarly, a keyword in headers or footers likely will indicate a very high risk as headers and footers are often used to mark a document for information security purposes, and a keyword in these areas indicates the likely presence of information potentially dangerous to information security, and possibly an improper review. In addition, the presence of “Revisions” and “Versions” within a Microsoft Word® document indicates the presence of what are commonly know as “Tracked Changes,” which are not visible by default in most versions of Microsoft Word® and have been known to compromise sensitive information. The presence of “Revisions” and “Versions” thus constitutes a very high risk.

As a further example, embedded objects also carry a security risk, and the risk is generally proportional to the type of embedded object. Object Linking and Embedding (OLE) objects are often considered the most dangerous type of embedded objects, and they can be sorted into risk categories based on the type of the OLE object. For example, an embedded Microsoft Excel Workbook® is considered much more of a risk to security than an embedded MSPhotoEdit object, because of the greater amount and type of data that can usually be found in the former. Compound embedded objects, like “Groups”, are considered less risky than OLE objects, but still receive a high risk ranking. Objects that are determined to not be visible in the document constitute a high risk. Such objects may be obscured by another object, or they could have the visible property set to false. Embedded pictures, often found in GIF or JPEG format, carry minimal risk if visible, unless they have been cropped or significantly resized and thus a significant portion may not be visible. Cropping traditionally has been used by the federal government and others to “sanitize” data, at least in appearance, so a cropped object indicates a very high risk because the cropped data may still be accessible. Objects that have been reduced in size also obscure information and constitutes a risk. The amount of risk is directly proportional to how much the object has been reduced.

The present invention uses a scoring algorithm that accounts for the variable risks associated with different objects and data within a document by assigning weights to the objects, data, and keywords, and then summing the weighted occurrences of all objects, data, and keywords. Certain keywords may be weighted more heavily than others. For example, the presence of the keyword “SECRET” is not as risky as the presence of the keyword “TOP SECRET.” Some types of information are so risky that any occurrence of this information may be considered fatal under some security protocols (i.e., the document may not be sent outside the security boundary, or may require 100% total review). In general, the algorithm may be represented by the following equation:

$$Risk = {\sum }_{AllKeyword s} Occurrence {s}_{Keyword} \times {Weight}_{Keyword} \times {Weight}_{Location} + {\sum }_{AllObjects} Occurrence {s}_{Object} \times {Weight}_{Object}$$

The weights and fatality status of individual information types can be configured to comply with the applicable security protocols. This information may be contained in a table assigning notional weights to various circumstances. An example of a partial notional weight table for a Microsoft Word® document is as follows:

| Object Type | Weight | Fatal |
|---|---|---|
| Keywords in Meta data | 10 | |
| Keywords in comments | 10 | |
| Keywords in Headers/Footers | | Yes |
| Keywords in Paragraphs and other locations | 1 | |
| Versions | | Yes |
| Revisions | | Yes |
| OLE Objects Type 1 (Excel workbooks, PowerPoint | | Yes |
| presentations, Word documents, Visio drawings, | | |
| MSProject schedules, and unknown OLE objects) | | |
| OLE Objects Type 2 (MSPhotoEdit & MSPaint) | 100 | |
| Cropped Images | 1000 | |
| Resized Images over threshold | 1 | |
| Resized Images over 75% | 10 | |
| Resized Images over 75% | 100 | |
| Resized Images over 90% | 1000 | |
| Groups | 100 | |
| Not Visible object | | Yes |

Of course, these weight values and fatality indicators are merely arbitrary examples, and actual values will vary depending on the security needs for each user or entity.

The resulting risk score can then be compared to one or more threshold values to determine how the document is to be handled. The threshold values will vary depending on the security needs for each user or entity. A single threshold value, for example, could be used to determine whether the document is to be passed or failed. And two threshold values, as a further example, could be used to sort documents into high, medium and low risk categories.

Auditing and tracking may be required in secure environments to ensure compliance with existing policy and to identify and quantify problems. The database included in this embodiment of the present invention provides both security personnel and administrators with information about electronic document transfers. The database may be used to identify the number and type of electronic documents being used to satisfy customer requirements and the number of possible incidents or problems encountered during the review process. This information is useful in allocating resources and for streamlining the security review process.

In another exemplary embodiment, the EDP 64 further comprises a Graphical User Interface (GUI) 67 that facilitates ease of use of the engine. The EDP 64 provides the interface that allows a human reviewer to analyze all of the contents of the document. This GUI uses a standard interface that is well-known to the user in an innovative way to display 100% of the user data contained in an electronic document. In one exemplary embodiment, the standard interface is similar to Microsoft's File Explorer.

To better understand how the EDP 64 works, it is first necessary to understand typical electronic document structures. A compound file, such as an OLE document, is actually an object-oriented collection of data streams. These streams are grouped together into storages. These storages can contain other storages in a hierarchical manner. The lowest level storage is called the root storage. The root storage contains all the information in the document and it is what we generally call the file or document.

When a document is embedded in another document, the embedded document's root storage becomes a substorage in the parent document. The streams can be complex structures themselves, and are usually composed of multiple objects, which are themselves streams. To parse the data in a compound file correctly, the file must be broken down into its elementary data streams. The elementary streams can be filtered and reassembled into a new document that is free of hidden data. It is important to note that compound files, such as OLE, and other complex non-compound file types, like HTML and XML, are all handled in similar fashion by the EDP 64.

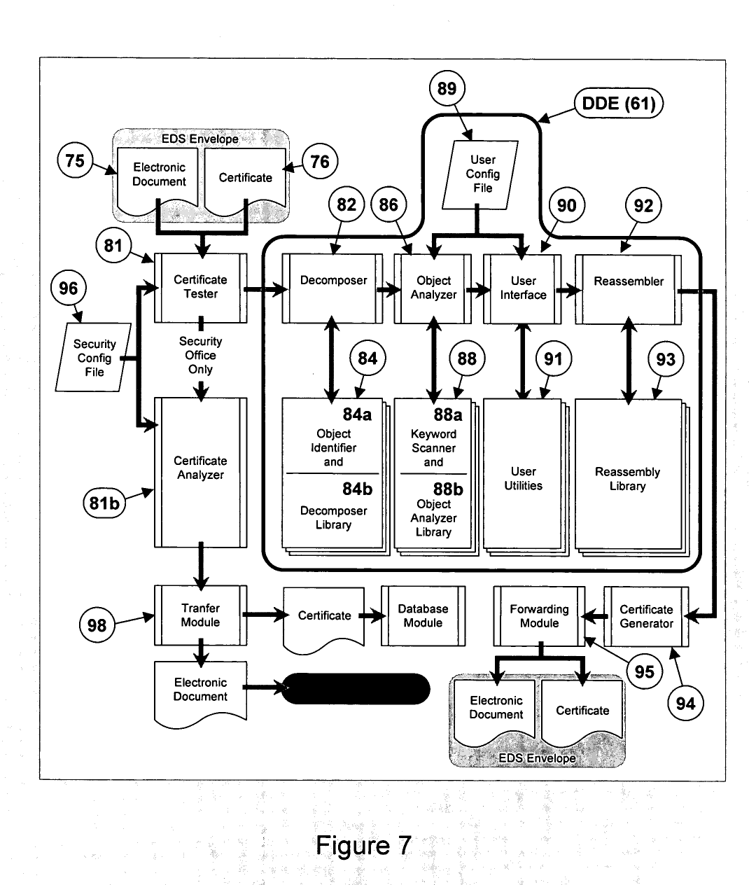

FIG. 7 shows a diagram of an EDP protocol (including the DDE 61) in accordance with one embodiment of the present invention. In this embodiment, the document 75 and its certificate 76, if any, are received by the EDP. Once the certificate is verified and analyzed by the certificate tester 81, the first step of the analysis process involves breaking the document down into its basic components with the decomposer 82. Because of the vast number of data types that are possible, this system uses modular libraries 84 to identify and temporarily store the basic components of the document. This modular structure allows new file and data types to be handled by simply adding new modules for use by the DDE as needed. The primary decomposer module is an object identifier 84a. The object identifier 84a examines specific binary sequences in the object to identify the object, and returns the result to the decomposer module 82. If an object cannot be identified, then the object cannot be analyzed and the DDE user will be notified. Once an object has been identified, the decomposer calls the appropriate library module 84b to decompose that object. The components of the object are then returned to the decomposer 82 to be identified. This process continues until all elemental objects have been recovered. Elemental objects are objects that cannot be further divided into meaningful objects. For instance, a text object can be further processed into words, words into letters, and letters into bits, but these objects have no meaning to the user; hence the text object is considered to be an elemental object.

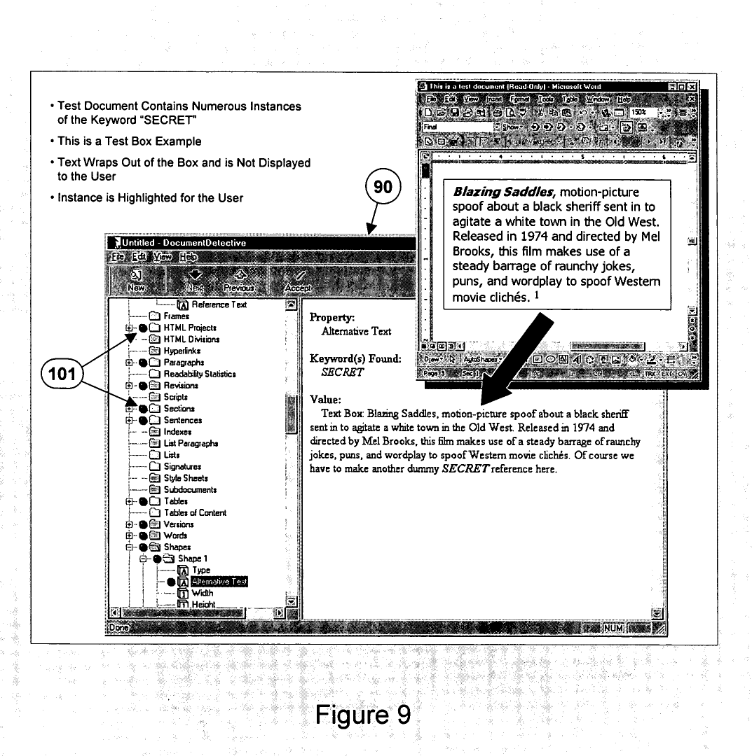

The next stage in the analysis process involves the object analyzer 86. Again, modular libraries 88 are used so that new object types can be added as required. A regular expression key word scanner 88a is the primary analyzer for all text objects. A list of key words is obtained from the user configuration file 89, and all text objects are scanned for the presence of these key words. Using a regular expression keyword scanner instead of an ordinary keyword scanner allows the DDE to detect keywords when the characters are not contiguous (i.e. finding the keyword SECRET in “S E C R E T”), and it allows the scanner to reject false positives (i.e. finding the keyword SECRET in the word “undersecretary”). Other object analyzer modules 88b may use the geometry of the objects to determine if an object is partially or completely obscured. Any information that is not visible in the presentation is marked for the user's review. The analyzer can also determine if objects have been cropped or resized. Any alteration to an object's presentation is also marked for the human user's review. An example of the DDE detecting text wrapping outside of a visible box is shown in FIG. 9.

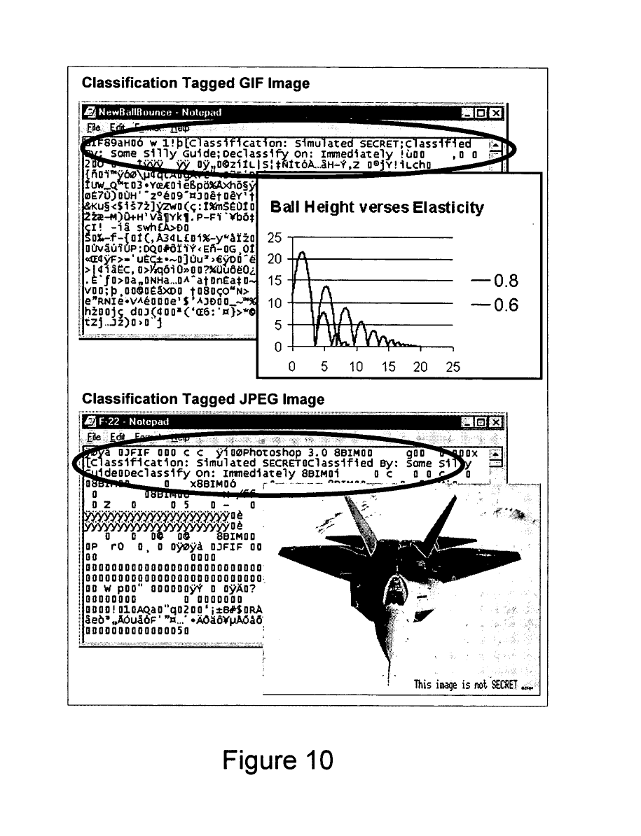

The analyzer 86 will also be able to review the content of images. If the images are marked at all, they are usually marked inside the image itself, which requires pattern recognition to detect. Pattern recognition may not be reliable in all situations and it usually requires considerable processing. However, most high level image formats allow non-visible text information to be imbedded in the file, as shown in FIG. 10. This technique is commonly used to identify copyrighted materials. As an alternative approach, images could be marked with these types of information. The images could then be checked for appropriate classification with a simple text scanner.

In yet another embodiment of this invention, a DDE object analyzer checks for data structures that should exist in the electronic document. The traditional approach is to look for keywords that should not exist, which is euphemistically called a “dirty word” search. Classified government documents are required to have identifying headers and footers, paragraph portion marks, and a classification block that identifies the authority for the classification and the declassification instructions. If these structures do not exist, then the user is notified through the DDE GUI. In this embodiment, the location of the keyword is as important as the keyword itself.

The third stage of the analysis brings in the element of human judgment and analysis. While the government user is required to review every object according to regulations, human nature and the sheer number of objects that can be contained in an electronic document makes this unreliable. The DDE GUI 90 addresses this problem by calling the user's attention to objects that appear to have a problem using a visual indicator, which is a red dot in this example 101. After reviewing an object, the user may choose to accept the object as it is, to alter or to convert the object using modular utilities, or to remove the object from the electronic document. The user's decision will be recorded as needed for the certificate 76. Some decisions may require the user to enter an explanation or justification. An example would be leaving an embedded worksheet in a document rather than converting it into an image, which is a much safer structure with significantly less hidden data. The user may need to adjust the data after the transfer, which could be a valid reason for keeping the worksheet as a worksheet.

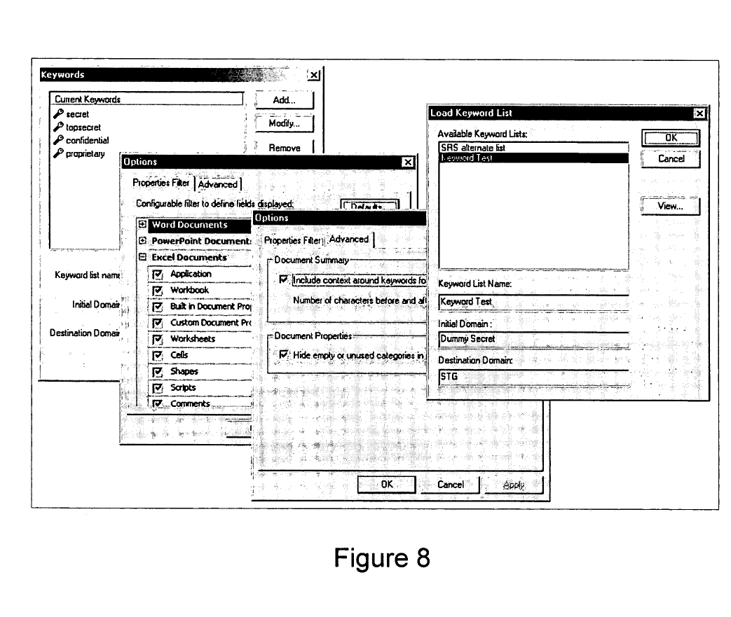

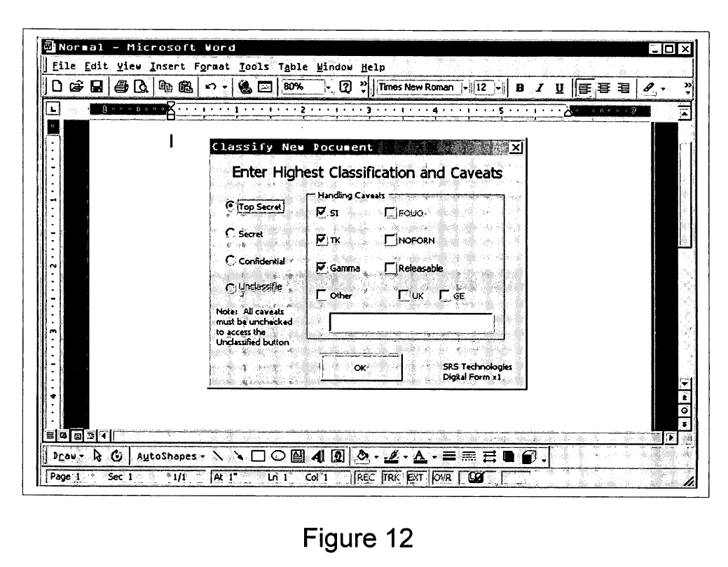

A number of user utilities 91 may be used in different embodiments of the invention. A text editor may be needed to make adjustments to text objects. Converters may be needed to change some objects, like embedded OLE objects, into safer objects, like an image. Image utilities may also be needed to display images at their full, uncropped resolution, and to remove the non-visible data from cropped and resized images. An image marking utility may also be needed to add or correct the image text fields discussed in the previous stage. Governmental and other users may be prompted by a classification utility to mark the file with appropriate security classifications. These would be available to the user through the user interface 90. Several screenshots of user interface panels and options are shown in FIGS. 8 and 12.

The information displayed to the user can be controlled through a configuration file 89. Some organizations may not be concerned about some data fields, such as the “Author” and “Company” fields in meta data. This information could be removed from the user's display, which would make it easier for the user to concentrate on more important objects. The configuration file 89 could also allow some automatic processing to occur. For example, correctly marked images could be automatically cropped and resized, or OLE objects could be automatically converted, all without user intervention.

The final stage of the analysis process is to reassemble the document with a reassembler 92, incorporating the user's modifications. A side benefit of the decomposition and reassembly process is the elimination of any file fragments that may have existed in the original file. The reassembly process also uses modular libraries 93 so the system can be easily enhanced to handle new object types. The new document is then passed to the certificate generator 94 and forwarding modules 95.

In some embodiments, automated transfers across security boundaries are possible using this system. If the document certificate meets certain parameters that are defined in the security configuration file 96, as determined by the certificate analyzer 81b, then the document under review could be submitted directly to the transfer module 98 without further review. Another embodiment of the DDE uses a scoring or ranking algorithm to assess the risk of transferring the electronic document without further review. This algorithm is based on a summation of scores for each internal data structure that considers the type, location and contents of the structure. If the document under review does not meet the necessary parameters, then the security office would have to perform a manual review before the document is passed to the transfer module 98. The transfer module 98 detaches the updated certificate 76b from the modified electronic document 75b and sends the certificate to the database 100. The electronic document is then transferred or prepared for transfer, such as being stored in a target domain specific location or folder where it can be easily transferred to the outside recipient.

In other embodiments, a user utility could be displayed with a simple, graphical interface when a new document is created. The user is allowed to select the appropriate classification for the new document. Using this type of utility reduces the occurrence of misspellings (e.g., “SERCET”) which might defeat most keyword scanners, including a regular expression keyword scanner. Attempting to bypass this menu causes the document to be marked at the system high level.

In other embodiments, a user utility may be used that detects an existing file that has not previously been processed. This can be done by placing custom meta-data tags in the document. If the tags do not exist, then a classification menu appears when the document is opened. Appropriate meta tags could also help identify documents that require special attention. For example, a document that was originally created as a TOP SECRET document and later sanitized to be a SECRET document is much more likely to contain problems than a document that was originally created as a SECRET document. This embodiment would provide an extension for the risk scoring algorithm.

In an exemplary embodiment, the associated method for implementing the DDE analysis process for a document or file comprises the following steps:

a. analyzing and verifying any certificate attached to the document or file;

b. identifying objects in the document or file;

c. alerting the user and annotating the certificate if an object cannot be identified;

d. decomposing the objects into components;

e. analyzing the objects;

f. reporting the results of the analysis to the user, and alerting the user to objects that meet certain conditions;

g. modifying, converting or deleting one or more objects;

h. reassembling the document or file from the treated objects;

i. generating a certificate documenting the results of the analysis and modifications, or modifying an existing certificate; and

j. forwarding the certificate and reassembled document or file to a transfer module or subsequent levels of review.

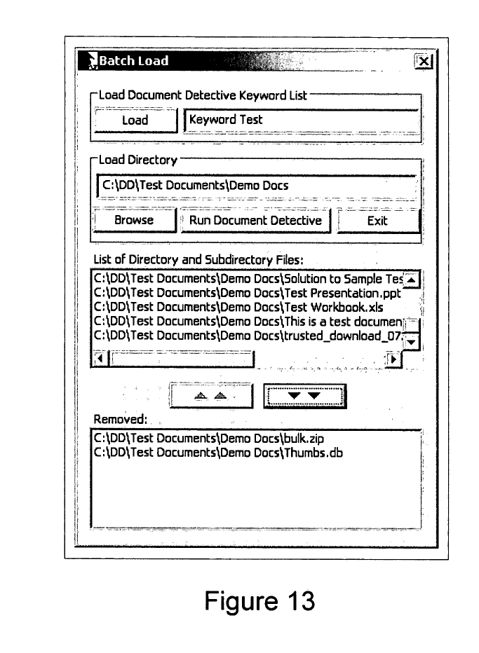

In yet another embodiment of the invention, the system may include a batch processing capability. In batch processing mode, the DDE runs in the background and processes a group or batch of documents. These documents may be grouped in a single folder for convenience. A copy of summary files resulting from the DDE analysis is then provided to the appropriate individuals. A screenshot of an embodiment of a batch load initialization dialog box is shown in FIG. 13.

Examples of the present invention have been presented for use within the national security field. However, it should be understood that the methods described could also be applied to the private sector to protect sensitive information such as trade secrets, financial information, confidential and privileged information, and the like. Recent legislation, such as the Health Insurance Portability And Accountability Act of 1996 (HIPAA) and Sarbanes-Oxley Act of 2002 that addresses Financial and Accounting Disclosure Information require enhanced information sharing, but they also require adequate protection of sensitive information. The present invention could also be used in alternative embodiments by individual users to protect their privacy when transferring information with their personal computers.

Thus, it should be understood that the embodiments and examples have been chosen and described in order to best illustrate the principals of the invention and its practical applications to thereby enable one of ordinary skill in the art to best utilize the invention in various embodiments and with various modifications as are suited for the particular uses contemplated. Even though specific embodiments of this invention have been described, they are not to be taken as exhaustive. There are several variations that will be apparent to those skilled in the art. Accordingly, it is intended that the scope of the invention be defined by the claims appended hereto.

We claim:

1. A system for analyzing a computer file, comprising:
a file decomposer operated by a computer process, said file decomposer comprising one or more object identification modules to identify objects within the computer file, and one or more object decomposition modules linked to the object identification modules, wherein said object decomposition modules decompose identified objects into component objects.

2. The system of claim 1, further wherein the component objects are subjected to further identification by the object identification modules and decomposition by the object decomposition modules, until all objects and component objects in a computer file have been reduced to a user-specified depth or until the component objects can no longer be decomposed.

3. The system of claim 1, further comprising
an object analyzer linked to the file decomposer, wherein the object analyzer receives the objects and component objects derived from the computer file by the general decomposition module and analyzes the content of said objects and component objects.

4. The system of claim 3, said object analyzer comprising one or more object analysis modules adapted to analyze particular object types.

5. The system of claim 4, wherein said object analysis modules comprise one or more key word scanners to analyze text objects, one or more image and pattern recognition scanners to analyze image objects, or one or more data structure scanners.

6. The system of claim 3, further comprising
interface means for displaying the results of the object analysis to a user.

7. The system of claim 6, wherein said interface means comprises a graphic user interface.

8. The system of claim 6, further wherein said interface means displays the results of the object analysis in a hierarchical manner.

9. The system of claim 6, wherein said interface means alerts the user to certain content within objects.

10. The system of claim 6, wherein said interface means further comprises means to accept input from the user with regard to one or more actions to take regarding one or more of the objects displayed.

11. The system of claim 10, wherein said user actions include accepting the object as is, altering or modifying the object by alternating or removing certain content from the object to create an altered or modified object, converting the object from one object type to a converted object of a different object type, or removing the object in its entirety.

12. The system of claim 11, further comprising
a reassembler module that reassembles the accepted, altered, modified, and converted objects into a modified computer file.

13. The system of claim 3, further comprising a certificate file linked to the computer file, wherein said certificate file documents the results of the examination and analysis of the computer file.

14. The system of claim 13, further comprising
a certificate handler for generating a new certificate file or modifying an existing certificate file linked to the computer file or a modified computer file, said certificate file documenting the results of the examination, analysis and reassembling of the computer file or modified computer file.

15. The system of claim 14, further comprising
means for one or more reviewers to review the modified file and certificate file.

16. The system of claim 13, further comprising
a transfer module, wherein the transfer module detaches the certificate file and sends the certificate file to a database for storage, and transfers or prepares to transfer the modified computer file to a recipient.

17. A system for evaluating the data content of one or more computer files, comprising:
means for identifying and analyzing the content of said computer files;
a user interface for allowing a user to examine the results from the analysis of said computer files;
means to remove or modify certain content with said computer files; and
means to create or modify one or more certificate files linked to said computer files to document the results of the analysis and modification of said computer files.

18. The system of claim 17, further comprising
means for scoring or ranking computer files based on content.

19. The system of claim 18, further wherein said means for scoring or ranking comprises assigning weights to occurrences of different objects, data or keywords based on their type, content, and location in the computer file, multiplying the weight assigned to each occurrence by the number of said occurrence in the computer file, and summing such weighted occurrences.

20. The system of claim 17, further comprising
means for additional review of said computer files and certificate files.

21. The system of claim 17, further comprising
means for sorting the computer files into target domain-specific locations or folders.

22. The system of claim 17, further comprising
means to send said certificate files to a computer database; and
means to send modified computer files to a recipient.

23. A method for analyzing a computer file, comprising the steps of:
identifying the types of objects contained in the computer file;
decomposing the objects into component objects; and
examining the component objects.

24. The method of claim 23, wherein the steps of identification and decomposition are repeated until all objects and component objects in a computer file have been reduced to a user-specified depth or until the component objects can no longer be decomposed.

25. The method of claim 23, further comprising the steps of:
determining whether specific content is present in each object or component object; and
determining appropriate action to be taken if said specific content is present.

26. The method of claim 25, further wherein the appropriate action to be taken is the creation of one or more modified component objects by altering or removal of the specific content from the corresponding component pieces.

27. The method of claim 26, further comprising the step of
creating a modified computer file by reassembling the modified component objects and any component objects from the computer file that were not modified.

28. The method of claim 27, further comprising the step of
modifying or creating a certificate file linked to the modified computer file to document the results of the analysis and any modifications.

29. The method of claim 28, further comprising the step of
submitting the modified computer file and certificate file to one or more reviewers for further review and analysis and possible modification.

30. The method of claim 28, further comprising the steps of:
sending the modified computer file to a recipient; and
sending the certificate file to a database for storage.

31. A method for evaluating the data content of one or more computer files, comprising the steps of:
identifying the content of said computer files,
analyzing the content of said computer files,
examining the results from the analysis of said computer files;
removing or modifying certain content with said computer files; and
creating or modifying one or more certificate files linked to said computer files to document the results of the analysis and modification of said computer files.

32. The method of claim 31, further comprising the step of:
scoring or ranking computer files based on content.

33. The method of claim 32, where the scoring or ranking of computer files comprises the steps of:
assigning weights to occurrences of different objects, data or keywords based on their type, content, and location in a particular computer file;
multiplying the weight assigned to each occurrence by the frequency of said occurrence in said computer file; and
summing all weighted occurrences for all occurrences of said objects, data or keywords in said computer file.

34. The method of claim 33, further comprising the step of
comparing the sum of all weighted occurrences for said computer file to one or more threshold values to determine how the computer file is to be handled.

35. The method of claim 31, wherein the steps of identifying the content of said computer files, analyzing the content of said computer files, examining the results from the analysis of said computer files, removing or modifying certain content with said computer files, and creating or modifying one or more certificate files linked to said computer files to document the results of the analysis and modification of said computer files, are repeated by one or more additional individuals or users.

36. The method of claim 31, further comprising the steps of:
sending said certificate files to a computer database; and
sending said computer files to a recipient.

37. A method for scoring or ranking the relative security risk of one or more computer files based on content, comprising the steps of:
assigning weights to occurrences of different objects, data or keywords based on their type, content, and location in a particular computer file;
multiplying the weight assigned to each occurrence by the frequency of said occurrence in said computer file; and
summing all weighted occurrences for all occurrences of said objects, data or keywords in said computer file to derive a risk score.

38. The method of claim 37, further comprising the step of
comparing the risk score for said computer file to one or more threshold values to determine how the computer file is to be handled.

39. The method of claim 37, wherein the weight assigned to an occurrence may be a fatality indicator.

40. The method of claim 37, further comprising the step of
sorting computer files into risk categories based on risk scores.
